(19) United States
(12) Patent Application Publication
(10) Pub. No.: US 2011/0120138 A1
(43) Pub. Date: May 26, 2011

(54) SYSTEM AND METHOD FOR CONVERSION OF HYDROCARBON MATERIALS

(75) Inventors: Severino Gaiffi, Cary, NC (US); John G. Cleland, Cary, NC (US)

(73) Assignee: HyCET, LLC, Apex, NC (US)

(21) Appl. No.: 11/912,743

(22) PCT Filed: May 1, 2006
(86) PCT No.: PCT/US06/16475

§ 371 Date: Dec. 29, 2008

Related U.S. Application Data
(60) Provisional application No. 60/676,185, filed on Apr. 29, 2005.

(51) Int. Cl. F02C 6/18; C01B 31/00; H01M 8/06; C01B 3/02

(52) U.S. Cl. 60/781; 423/445 R; 429/426

(57) ABSTRACT

A process for converting coal and other hydrocarbon solid fuel feedstocks comprises reacting the feedstock in a first stage exothermic hydropyrolysis reaction zone with a hydrogen-rich gas stream for producing methane. The methane from the first reaction zone is dissociated in a second endothermic reaction zone to produce solid carbon and hydrogen-rich gas using heat mainly from the first reaction zone. All heat to promote the desired extents of reaction in each reaction zone is provided solely from the exothermicity of chemical reactions in the process. The majority of the gas is recirculated from the second reaction zone to the first reaction zone. Hydrogen gas is recovered to produce electrical energy for reducing carbon dioxide emissions.

### BACKGROUND ART

The present invention relates to a system and method for conversion of coal and other solid hydrocarbon materials primarily into solid carbon and gaseous hydrogen. The solid carbon recovered from the process can be used in a variety of products, including structural, filtration and clean fuel products. The hydrogen is mainly intended for use as a clean fuel to produce electricity from fuel cells or specialized gas turbine/electrical generation sets. The hydrogen may also be used as a high value chemical processing feedstock or as a portable fuel for mobile engines.

Coal and methane hydrates are the most abundant fossil energy sources, and the best options for transitioning world energy production from oil and gas to continuously renewable, solar-dependent energy conversion and nuclear fission/fusion energy sources. Methane hydrate energy recovery is in its infancy and highly problematical. Coal combustion and gasification energy conversion is well demonstrated, but the combustion of coal and its synthesis hydrocarbon products can be harmful to health and environment. The increasing recognition of the contribution to global climate changes of carbon dioxide from hydrocarbon fuels combustion is now a crucial consideration in energy production and conversion.

The process of this invention introduces unique approaches to global energy and climate change solution options, including 1) a very significant increase in the utilization of coal to produce electrical power by emphasizing the exceptionally efficient conversion of the hydrogen in coal to electricity, thus practically eliminating carbon dioxide emissions altogether, and 2) utilizing the carbon from coal mainly as a structural product, with the option of storing the carbon as a fuel which is much cleaner than coal and which can be used if and when the consequences of carbon dioxide emissions are lessened.

Options competing with the present invention include methods of water electrolysis, such as by nuclear reactor/electric power generation, to produce hydrogen but at a net energy loss. Other processes convert coal by direct combustion or to gases or liquids for subsequent combustion with the carbon dioxide from such processes being sequestered at great cost and hazard in the oceans or underground. Recent advances in these processes emphasize small improvements in energy conversion efficiency to conserve fuel, although fuel conservation can be better addressed by energy-use conservation approaches.

The process of this invention can produce energy without carbon dioxide emissions and at lower cost. The process simultaneously produces carbon products that can be used as superior structural building blocks at cost lower than other structural commodities or can be stored as a clean fuel for later use, practically replacing the coal from which it was derived. For energy conversion, the increased cost of using more coal is significantly less then the cost of sequestering carbon dioxide. A potential disadvantage of the process of the present invention is that coal and similar hydrocarbons must be used at more than two times the rate compared to combustion processes sequestering carbon dioxide to produce the same amount of electricity if carbon conversion to electricity is avoided. This disadvantage can be mitigated by the use of lower cost, lower BTU, high sulfur, or less desirable coal.

The advantages of and means for using hydrogen to directly produce electrical energy or process heat with only water as a byproduct are well known. The application of solid carbon as a commodity building block is now emerging. With the discovery of carbon nano tubes many new and replacing applications are facilitated by this invention.

Carbon materials can be used in a wide range of applications, such as in transportation, electronics, electromagnetic shielding, electrical conductors heat sinks, electrodes, additives to structural materials, filtration of contaminants, basic structural components, packaging, and building materials. Carbon is also an excellent candidate for economical recycling. Conventional carbon products include activated carbon, carbon black, charcoal, graphite, and carbon fiber impregnated composites. Important new carbon markets include (1) fillers for asphalt and cement, (2) char and bulk carbon as a “clean” fuel for combustion in power plants and (3) large scale structural carbons. Emerging markets, such as those for very high strength, high conductivity, light weight, high heat conductivity, chemical inertness carbon nanofibers and new types of carbon composites, will benefit from increased capacity and consequent lowered cost. Carbon could eventually replace most of the lumber, steel, aluminum, titanium, and other structural formulations as the primary building material.

Some publications of research results of more than 25 years prior to the present contain descriptions of coal hydropyrolysis and, in separate sources, of methane cracking. The concepts are not previously combined in such research. Other, more recent art, such as U.S. Pat. No. 5,427,762; Grohse, Steinberg; Jun. 27, 1995, U.S. Pat. No. 5,767,165; Steinberg, et al.; Jun. 16, 1998, U.S. Pat. No. 5,344,848; Steinberg, et al.; Sep. 6, 1994, U.S. Pat. No. 6,911,057; Lyon; Richard K.; Jun. 28, 2005, and U.S. Pat. No. 5,955,039; Dowdy; Thomas E.; Sep. 21, 1999, address issues of hydrogen production from coal but digress significantly from the present invention in terms of reactants and products, sources of heat and methods of heat transfer, reactor designs, rates of reactions, and reaction conditions. The fundamental ideas for carbon applications and reduction of atmospheric carbon dioxide appear to be different or non-existent in prior art. The entire contents of the above-cited patents are incorporated herein by reference in their entirety.

### DISCLOSURE OF INVENTION

According to the present invention, a process is provided for converting coal and other hydrocarbon solid fuel feedstocks primarily into two product constituents of solid carbon and gaseous hydrogen. The process comprises the steps of reacting the feedstock in a first stage exothermic hydropyrolysis reaction zone with a hydrogen-rich gas stream with the primary object of producing methane by devolitilization of the feedstock and reaction of the feedstock carbon with hydrogen. The methane from the first reaction zone is dissociated in a second endothermic reaction zone to produce solid carbon and hydrogen-rich gas using heat mainly from the first reaction zone. All heat to promote the desired extents of reaction in each reaction zone is provided solely from the exothermicity of chemical reactions in the process. The majority of the gas is recirculated from the second reaction zone to provide the hydrogen-rich gas stream to the first reaction zone. Hydrogen gas is recovered to produce electrical energy such that carbon dioxide produced as emissions from the process electrical energy production is less than carbon dioxide emissions from combusting the same feedstock with oxygen.

### BEST MODE FOR CARRYING OUT THE INVENTION

A process according to the present invention comprises pyrolysis of solid hydrocarbon materials at elevated temperatures and pressures in a hydrogen-rich environment and recovery of most of the carbon and hydrogen in the solid hydrocarbon materials as separate components. The process includes two fundamental reaction zones: 1) conversion of solid hydrocarbon materials by high-temperature, high-pressure hydropyrolysis in a hydrogen-rich atmosphere, in which the solid hydrocarbon material is devolatilized and the volatile products and remaining carbon react with a high concentration of hydrogen gas to produce a gas with a predominant concentration of methane, and 2) decomposition of the methane produced in a second high temperature pyrolysis reaction to produce solid carbon and a gas with high hydrogen concentration. A variety of process conditions may be used for methane decomposition (methane cracking) for generating a variety of carbon products.

Hydrogen charged to the reaction process is reacted with carbon in the first reaction and regenerated in the second reaction. Hydrogen in the solid feedstock introduced into the process is removed from the process, while most of the regenerated hydrogen is continuously recycled back from the second reaction to the first reaction, thereby providing a unique gas mixture for controlling the desired extent of reaction of the carbon in the solid fuel and the ultimate product mix.

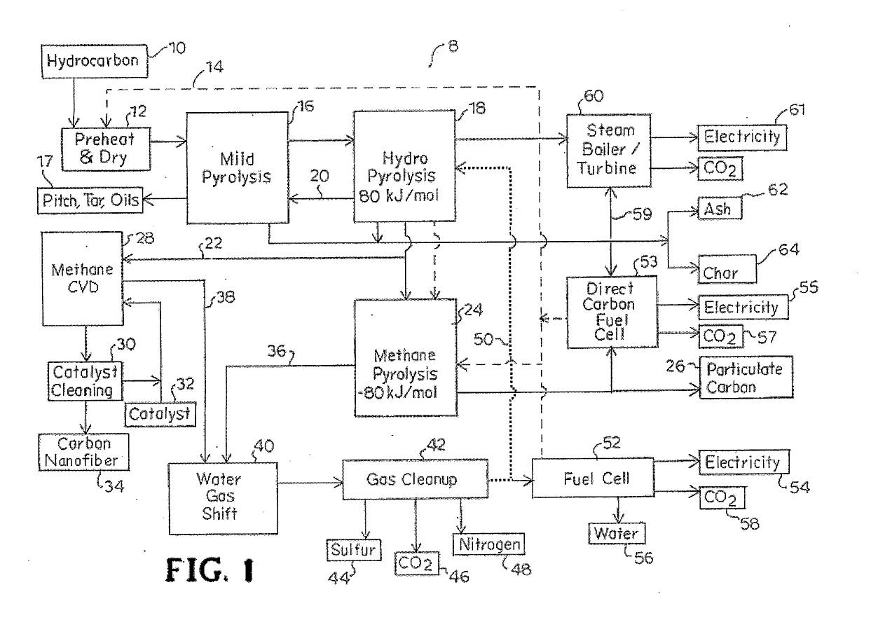

Unreacted solid byproducts from the first reaction, such as carbon char, are essentially free of contaminants such as sulfur and therefore can be used in a combustion boiler for steam/electricity generation or as an active filtration matrix. Hydrogen can be converted to electricity at energy conversion efficiencies greater than 50% with CO₂ production practically eliminated. An embodiment diagram of the process described by the present invention is shown in FIG. 1 as combined process 8. Alternate modifications of the process are shown in subsequent figures. Mass transfer steps are designated by solid lines, while dashed lines refer to heat transfer and dotted lines show the hydrogen recycling path in the process. A preferred feedstock is a solid hydrocarbon material 10, including coal, such as anthracite, bituminous, sub-bituminous coal, coke, lignite, and the like.

The feedstock may also comprise biomass or other high hydrocarbon solid waste, which has been reduced to proper size and moisture content. The hydrogen content for these feedstocks generally ranges from about 1% to about 7% by weight. The carbon content generally ranges from about 40% to about 80% by weight. By the selection or the mixing of particular hydrocarbon materials for the feedstock, the output for carbon and hydrogen can be adjusted.

The hydrocarbon feedstock 10 enters a preparation step 12 where the feedstock 10 is preheated and dried. Drying can be achieved by means known in the art, such as air drying of stored feedstock, use of excess heat from a subsequent process step, or heating in fuel pulverizers. As part of the preparation step, the hydrocarbon feedstock may be transferred into a purge hopper (not shown) where the air may be replaced by an inert gas, such as nitrogen, or by hydrogen-rich gas.

The preparation step 12 can be made more effective if performed after the feedstock is crushed or pulverized to fine particles. A smaller particle size is advantageous in the hydropyrolysis process since smaller particles have a larger surface area and react more uniformly and more rapidly. Where coal is used as the feedstock, the process according to me present invention allows the use of conventional equipment, such as pulverized coal mills, for fuel preparation and handling. The hydrocarbon feedstock may be introduced by screw feeders or in a high solids concentration with liquid slurry.

The hydrocarbon feedstock 10 is converted into a methane-rich gas by hydropyrolysis in an exothermic reaction at elevated temperatures and pressures in a hydrogen-rich atmosphere. A mild pyrolysis stage for producing tar and pitch at lower temperatures may be included either in parallel with the other reaction stages or in series before the hydropyrolysis stage. The process for hydropyrolysis does not require the optional mild pyrolysis.

Solids and gases are transferred to the main hydropyrolysis reactor 18, which operates at temperatures of about 500° C. to about 1200° C. and pressures of about 2 bars to about 80 bars in the presence of primarily hydrogen gas. The present invention emphasizes rapid reaction in the hydropyrolysis reactor 18. Short residence times (e.g., less than 30 seconds are anticipated for both gas and solids). A gas stream 22 exits the main hydropyrolysis reactor 18. The gas stream 22 comprises CH₄, H₂, H₂O (steam), CO, CO₂ and depending on the feedstock used, and may include H₂S, NH₃ and trace metals. In this embodiment, excess heat 20 from the main reactor 18 or excess heat from fuel cells, gas turbines, or steam turbines 60 can be used to preheat the feedstock or the reactors.

The hydropyrolysis process creates a gas stream 22 which is rich in methane, with extents of conversion of carbon to methane potentially ranging up to about 90% methane. The methane-rich gas stream 22 can be used to generate one or more carbon products. In the process shown in FIG. 1, the methane-rich gas stream 22 is divided and used in different reactors for the production of a particulate carbon. In the production of particulate carbon, the methane-rich gas stream 22 is fed to a reactor for methane pyrolysis 24, also referred to as a methane-cracking reactor. In the methane-cracking process, methane is converted into hydrogen and carbon. The methane pyrolysis reactor 24 may operate at about the same temperature and pressure conditions as the main hydropyrolysis reactor 18. The decomposition of methane into carbon particles and hydrogen is typically represented by slower reaction kinetics than the rates of hydropyrolysis conversion. The bulk carbon may be collected, for example by screw feeder removal to an exit hopper 26. The carbon can be functionalized to the finished product through a known variety of thermal, mechanical or chemical treatments. The bulk carbon may also be screened and mixed for uniformity. The amount of bulk carbon generated can be controlled by the concentration of methane in the reactor and the reaction conditions.

On an ash-, nitrogen-, sulfur-, and chlorine-free basis, a simplified hydropyrolysis reaction for representative bituminous and sub-bituminous coals can be respectively summarized by the stoichiometric equations:

CH_{0.8}O_{0.08}+1.7H₂→CH₄+0.08H₂O˜H₂₉₈=−18 Kcal/gmol

CH_{1.0}O_{0.2}+1.7H₂→CH₄+0.20H₂O˜H₂₉₈=−18 Kcal/gmol

In actuality, the product gas may also contain excess hydrogen, carbon monoxide, and carbon dioxide depending on pressure and temperature conditions in the reactor. In addition, there may also be quantities of ammonia and hydrochloric acid resulting from nitrogen and chlorides in the feedstock coals.

The second process step of methane pyrolysis to produce carbon and hydrogen is summarized by

CH₄→C+2H₂˜H₂₉₈=+18 Kcal/gmol

Theoretically, the reactions can be thermodynamically balanced so that no substantial heat input is required and the overall reaction for a representative bituminous coal is represented by

CH_{0.8}O_{0.08}S_{0.016}N_{0.015}→C+0.28H₂+0.08H₂O+0.016H₂S+0.015NH₃, plus ash.

The hydrogen in ammonia and hydrogen sulfide may be mostly recovered by gas cleaning, and the water vapor can be further shifted to hydrogen by establishing conditions to drive the reaction

CO+H₂0→H₂+CO₂

to produce additional hydrogen. Carbon yields from this process may depend not only on thermodynamic conditions but also on excess hydrogen and other gas components produced in the hydropyrolysis reaction. The theoretical balance between the exothermicity of the first reaction and the endothermicity of the second reaction can serve to minimize heat energy addition from out side the reactions' boundaries.

The process of the present invention places emphasis upon the use of entrained bed reactors for both hydropyrolysis of solid feedstock and for methane cracking. Practically all successful hydropyrolysis experiments exhibiting high degrees of conversion of the carbon in coal to methane have been accomplished with entrained flow of the solids in the gas stream. The reaction kinetics and heating rates can be enhanced when solids particles are very small, especially down to the sizes of finely divided powders. The methane cracking reaction with the solids diluted in a significant volume of gas allows more rapid reactions, simple solids recovery, and good mixing of reactants and catalysts. Entrained bed reactors can be operated without the solids agglomeration problems of such materials as caking coals which can defeat the operation of such reactor types as moving or fixed beds of solid materials. Fluidized bed reaction is a second possibility for the new process, if agglomeration can be avoided. Fluidization potentially offers some improved mixing, especially for example of solid materials like calcium carbonate added for sulfur capture. The energy required for solids size reduction is also less than for entrained bed fuels.

Depending on the process conditions a variety of other carbon products can be generated. For example, bulk carbon yields from this process may depend not only on feedstock carbon content and thermodynamic conditions, but also on the amount of excess hydrogen, oxygen and other gas components produced in the hydropyrolysis reaction. Some of the methane decomposition processes may require catalysis for the formation of specific carbon products, such as carbon nanofibers and graphite. Other processes may require specific atmospheric conditions.

As shown in FIG. 1, a portion of the methane-rich gas stream 22 is also directed to a carbon nanofiber reactor 28. The carbon nanofiber reactor 28 may operate at low pressures and at temperatures in the range of about 1000° C. to about 1200° C. A catalyst is used in order to accelerate carbon fiber growth. A suitable catalyst is ferrocene, although other catalysts, such as Co-, Fe-, or Mo-containing metals, can be used. Preferably, the catalyst is introduced by the floating catalyst method together with the methane gas stream 22. In order to preheat the combined gas and catalyst stream, the gas stream 22 is introduced through a pipe which enters the carbon fiber reactor 28 at one end and is disposed along the central longitudinal axis of the carbon fiber reactor 28 for nearly the entire length of the reactor. The gas stream 22 exits the pipe at the distal end of the carbon fiber reactor 28, which causes the gas stream 22 to be diverted 180°. Carbon nanofibers are grown by chemical vapor deposition (CVD) onto the catalyst. The type of nanofibers generated, their size and properties depends on many process parameters including process temperature, methane temperature, catalyst used and gas additives, such as H₂S, steam, NH₃ content in the reaction zone, exposure time and the like. A bypass line between WGSR 40 and the Gas cleanup 42 (not shown) can be used to dose a defined amount of unconditioned gas into the carbon nanofiber reactor 28 for process acceleration.

The carbon nanofiber product and catalyst exit the carbon fiber reactor 28 to a catalyst cleaning step 30 where a chemical bath is used to recover the catalyst material 32 for reuse in the carbon fiber reactor 28. Carbon nanofiber 34 is recovered from the catalyst cleaning step 30 for further processing and finishing.

As described above, during the hydropyrolysis process, the hydrocarbon materials are converted mainly to methane, hydrogen, and water gas, with carbon dioxide and carbon monoxide also present in small quantities near equilibrium. In order to optimize the hydrogen recovery, a water-gas shift reactor may be used to convert carbon monoxide to carbon dioxide with the presence of steam. The gas stream 36 exiting the methane pyrolysis reactor 24 and the gas stream 38 exiting carbon nanofiber reactor 28 have a reduced methane content and a high hydrogen content. The gas stream 36 may still contain water gas, nitrogen and sulfur compounds and CO. Both gas streams 36, 38 are routed to the water-gas shift reactor 40. In the water-gas shift reactor 40, CO and steam are shifted to hydrogen and CO₂ to produce additional hydrogen from the steam for downstream use. WGSR's are known in the art. The gas moves from the water-gas shift reactor 40 to a multi-step gas cleanup 42 where the gas is cleaned of undesirable components, such as CO₂, nitrogen- and sulfur compounds, to produce a gas stream primarily comprising hydrogen and methane for downstream use. A gas streams from less efficient methane conversion processes such as the nanofiber reaction 28 or graphite reaction 102 maybe routed to a more efficient methane conversion reaction such as the methane pyrolysis process 24 before entering the water gas shift.

Gas cleanup for the hydrogen recycle stream representing the majority of the gas is performed such that unwanted gases are tolerated but do not accumulate. The gas cleanup for the exiting gases is tailored to the tolerance levels of the subsequent equipment. For example, fuel cells can tolerate CO₂ and NH₃ with reformers. If used in gas turbines, the specifications for use of hydrogen-rich gas for turbines may be designed for gas cleanups 42 which may be performed using methods well known in the art or which are in development. Preferably, the gas cleanup is taking place at elevated temperatures and pressures to avoid reheating and pressurizing of the recycle gas. Nitrogen gas separated in the gas cleanup 48 may be used in the feed hoppers to purge the incoming feedstock from air and humidity. Hydrogen-rich gas that is hot and pressurized enhances the performance of fuel cells and gas turbines. When cooling the gas is a requirement for efficient gas cleanup, then a heat exchanger may be used to capture the heat for transfer of the heat energy back into a recycle gas stream.

As shown in FIG. 1, fuel cells 52 may be used in the present invention to convert hydrogen and methane-rich gases, as well as solid carbon into electricity. Solid oxide fuel cells (SOFC), molten carbonate fuel cells (MCFC), phosphoric acid fuel cells (PAFC), or any new fuel cells, preferably with high conversion efficiencies and high operating temperatures, are suitable for use according to the present invention, particularly with a gas stream including a mixture of methane and hydrogen. Special anode arrangements are used for this gas mixture, which are well known to fuel cell producers. In these types of fuel cells, internal reforming may take place that converts remaining methane into hydrogen for subsequent conversion into electricity 54. Distilled water 56 is also generated from the process. The distilled water 56 can be mineralized and sold as drinking water or sold as distilled water for industrial use. The carbon contained in the methane exits the fuel cells as CO₂ 58. As described above, heat 14 from the fuel cells 52 is used to condition the feedstock 10 or is used for electricity conversion in a steam turbine 60.

A bypass line (not shown) may be provided such that some cleanup of the gas stream to the fuel cells 52 can be reduced or eliminated. For example, it is known that the presence of some CO gas may not harm some fuel cells and the presence of some CO₂ gas in the feed stream of the fuel cells 58 can enhance their efficiency. In such case, the gas cleanup bypass line may allow some bypass of CO and/or CO₂ gas to the fuel cells 58.

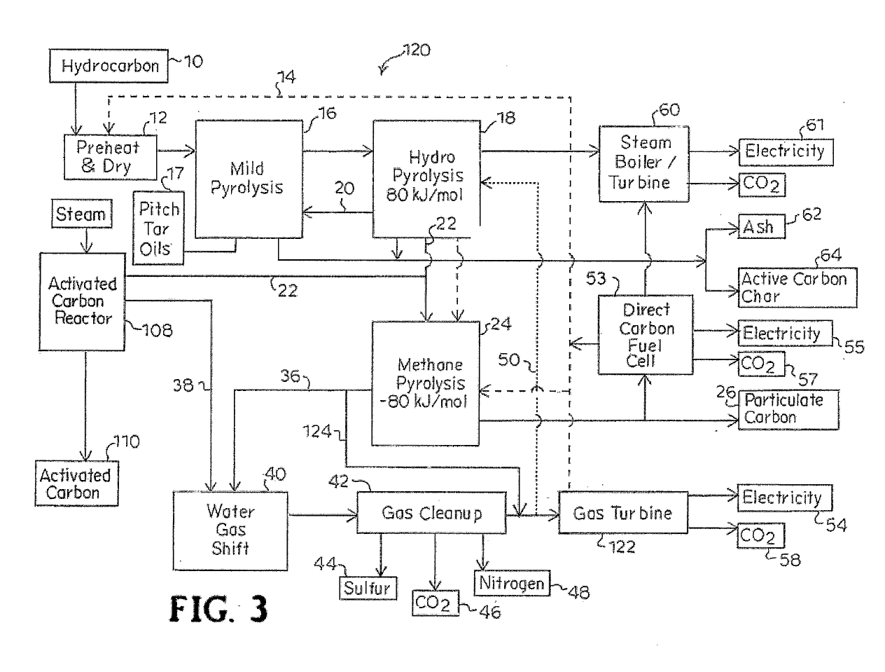

Excess heat from the main hydropyrolysis reactor 18 and from the fuel cells 52 and 53 may be used in a steam turbine 60 for conversion to electricity 61. Suitable steam boilers and steam turbines are well known in the art. Alternatively, a gas mixture of methane and hydrogen could be by a gas turbine type arrangement, should there be a preference for “traditional technology” and lower capital cost for electricity generation, see FIG. 3, item gas turbine 122.

Alternatively, excess carbon products can be used by conventional boiler and steam turbine technology 60 to create electricity. Some of the carbon released from the hydropyrolysis process such as char 64 may be contaminated by ash and best used for electricity conversion.

Some of the char 64 is defined herein as “active carbon” since char from the hydropyrolysis processes has high surface area and may be also used for some active carbon applications if activated. The amount of ash 62 is the original content of ash 62 in the hydrocarbon material. The amount of char 64 generated is regulated by the temperature and pressure equilibrium conditions in the hydropyrolysis reactors 16, 18 and by the amount of recycled hydrogen gas 50. Ash 62 and char 64 can be separated where desired by means of gravity settling from a gas stream or other physical means. Cooling techniques for ash and char during removal from reaction zones may incorporate the means for recovering heat, which can be used in such applications as fuel drying or methane decomposition. The char 62 and active carbon 64 may be used in the steam boiler and steam turbine system 60 to increase the total amount of electricity generated or sold as a clean coal replacement product to existing coal power plants.

Carbon products, low in ash and sulfur, with high surface area, such as activated carbon, carbon black, nano-sized coke, carbon nanofibers, and the like, can also be converted by direct carbon fuel cells (DCFC) 53 into electricity 55 at high efficiency rates. This technology is described in the U.S. Pat. Nos. 6,200,697 [Pesavento; Philip V., Mar. 13, 2001] and 6,214,485 [Barnett; Scott A., Murray; Erica Perry; Tsai; Tsepin, Apr. 10, 2001], the contents of which are hereby incorporated by reference. DCFC outputs are electricity 55, CO₂ 57 and heat 59. The waste products are heat and concentrated CO₂ gas; the latter could be used for commercial applications.

Processes such as the hydropyrolysis reaction and fuel cells create excess heat. This heat can be converted into electricity through a steam turbine 60, as described above. The heat generated by the two processes can also be used within other process steps that require heat. For example, some of the heat generated can be used to dry the incoming feedstock to reduce the moisture content, thus making the process more efficient.

An initial charge of hydrogen gas is needed to create a sufficiently reducing atmosphere for the hydropyrolysis reaction, but thereafter, a continuous stream of hydrogen-rich gas required for the hydropyrolysis process equilibrium conditions can be maintained by recycling hydrogen-rich gas generated by any of the multiple carbon conversion processes. This recycle gas stream 50, preferably taken after water-gas shift and gas cleanup, may maintain a highly reducing atmosphere in the reactors. Adjustments to the hydrogen gas recycle 50 process allow further balancing of the product output. By using more or less recycle gas, the char/active carbon 64 content made can be adjusted. Conversely, carbon conversion of the solid feedstock may be limited by reaction temperatures and pressure to produce more char byproduct and less methane gas. Lower recycle streams may result in higher carbon char removal from the hydropyrolysis reactor 64 and therefore a reduced amount of methane is generated for the downstream reactions. Further, the hydrocarbon material feedstock 10 may have variable oxygen content. In order to maintain a highly reducing atmosphere and an equilibrium favoring hydrogen production the hydrogen-to-oxygen mole or gas volume ratio should be high, preferably above 15. Since the hydrogen recycle stream 50 is depleted of oxygen, the recycle stream can provide the desired H/O ratio in the hydropyrolysis reactor.

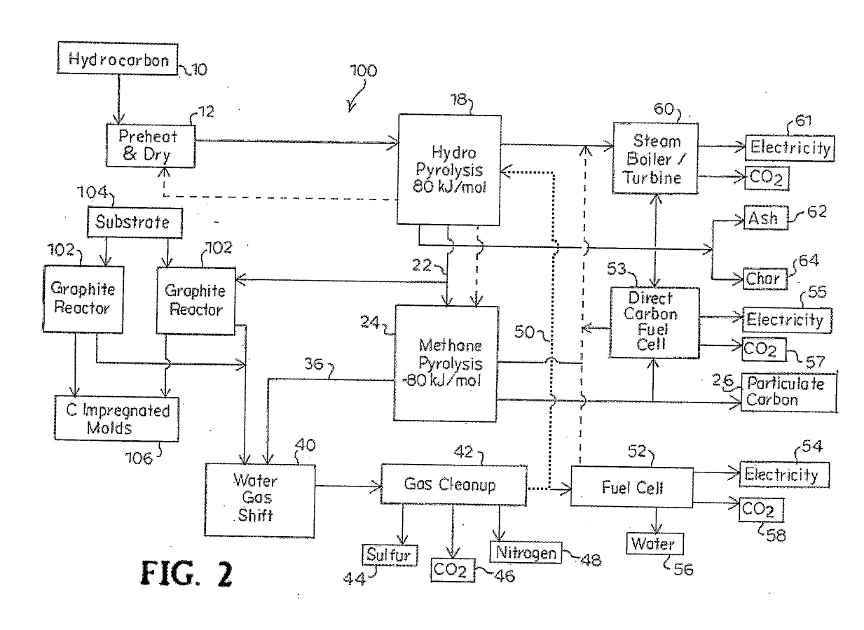

In other embodiments of the present invention, a recycle stream comprised of gases produced in various parts of the process may be used to balance carbon product outputs. In some embodiments, the mixture of gas streams is tailored to optimize production of particular carbon products. Mixtures of clean gas (methane and hydrogen) and process gas (methane, hydrogen and impurities such as oxygen, nitrogen, sulfur, etc.) can be tailored to provide a feed gas best suited for each of the methane-cracking processes. A second embodiment of a process, according to the present invention, is shown in FIG. 2 and generally designated as a combined process 100. In this embodiment, a single hydropyrolysis reactor 18 is used to convert the hydrocarbon feedstock 10. Multiple reactors in parallel are favored when reaction times are elongated. This is the case when slow growth takes place like in the production of graphite and composites. Further multiple reactors to maybe introduced in series or parallel to maintain a continuous stream of products, to expand existing capacity or to introduce redundancy in the processes.

The stream from the hydropyrolysis reactor 18 is divided, as described above, and one of the gas streams 22 is used for the production of carbon-impregnated compounds by chemical vapor deposition on substrates. The methane-rich gas stream 22 is directed to a graphite reactor 102. As shown in FIG. 2, a plurality of reactors 102 may be provided in series or parallel, depending on a particular application. Because the described graphite production process is a batch process, multiple reactors may equalize the capacity of methane consumption in the product stream. The graphite reactors 102 are loaded with graphite, carbon, glass fiber, and ceramic or polymer mat molds. These prefabricated molds 104, are made by a separate process and provided to the reactors 102. The pressurized methane-rich gas stream 22 is injected at a constant feed rate into the reactors 102 and forced through the porous molds. During the chemical vapor deposition process, carbon is deposited in the voids and on the surface of the substrate and result in a carbon—composite product 106. The carbon composites have superior mechanical properties, are lightweight and may replace many structural products. The same process can coat highly conductive carbon electrodes for fuel cells. When the methane-cracking efficiency is low, a recycle gas stream (not shown) may be directed into the bulk carbon reactor for additional methane cracking.

A third embodiment of a process according to the present invention is shown in FIG. 3 and generally designated as combined process 120. In this embodiment, a conventional gas turbine 122 replaces the fuel cells. In order to provide a suitable fuel to the gas turbine 122, the gas cleanup step 42 is modified. One modification is to direct a stream 124 of a portion of the uncleaned gas from the methane pyrolysis reactor 24 and mix it with the cleaned methane and hydrogen-rich gas stream from the gas cleanup 42 to dilute any impurities going into the gas turbine 122. Gas cleanup 42 is conducted to safeguard the turbine from damage from sulfur and other constituents. However, use of the gas turbine 122 may not require the removal of nitrogen and CO₂. Thus, a modification to the process (not shown) may be to bypass the nitrogen and CO₂ cleanup for the use of gas in the turbine. Nitrogen compounds have additional energy stored that can be converted to electricity in the gas turbine 122.

In this embodiment, the gas stream 22 from the hydropyrolysis reactor 18 is used for the production of activated carbon. An activated carbon reactor 108 is provided for generating activated carbon 110 by a steam activation process.

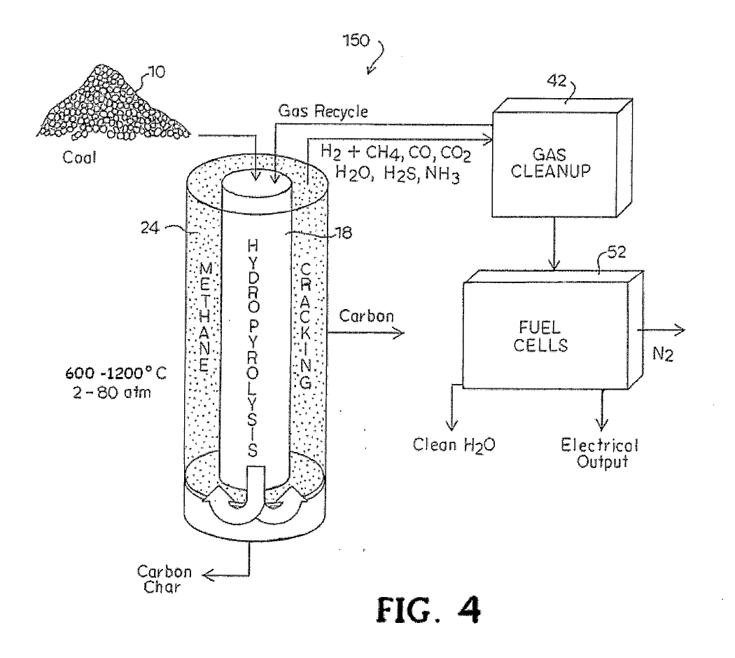

The pyrolysis processes, according to the present invention, can be conducted in a single reactor or in multiple reactors. FIG. 4 shows an embodiment of a single nested reactor for use in the process according to the present invention, generally designated as combined process 150. In this arrangement, the main hydropyrolysis reactor 18 may be nested inside the methane-cracking reactor 24. The nested arrangement increases the energy efficiency of the described processes. Heat transfer can take place through the common wall of the reactors. More particularly, hydropyrolysis is an exothermic process generating heat, and methane cracking is an endothermic process, the optimum operating parameters of which are near the process parameters for the hydropyrolysis. Nesting the two reactors 18, 24 provides for heat transfer from the exothermic to endothermic reaction zones, thus eliminating the need for recirculating inert solids, such as alumina, as a heat transfer device. The methane-cracking reactor 24 uses heat generated by the exothermic reaction of the hydropyrolysis of the hydrocarbon feedstock. Wall-heat conduction properties and emissivities may be designed to properly distribute heat to allow constant temperature operation of the respective reaction zones.

Each of the figures shows examples of combinations for the conversion of hydrocarbons to a variety of carbon products and for the conversion of carbons and hydrogen to electricity. There is a plurality of other combinations possible that should not be excluded by the examples shown.

Favored methods for electricity production would be expected to involve the elimination of the majority of CO₂ emissions. This invention addresses this ideal solution through the utilization of the hydrogen product. Furthermore, the carbon materials generated by the process make the use of high volume carbon fillers in plastics, cement, asphalt etc, and structural materials economically feasible.

1. A process for converting coal and other hydrocarbon solid fuel feedstocks primarily into two product constituents of solid carbon and gaseous hydrogen, the process comprising the steps of:
reacting the feedstock in a first stage exothermic hydropyrolysis reaction zone with a hydrogen-rich gas stream with the primary object of producing methane by devolitilization of the feedstock and reaction of the feedstock carbon with hydrogen;
dissociating the methane from the first reaction zone in a second endothermic reaction zone to produce solid carbon and hydrogen-rich gas using heat mainly from the first reaction zone;
providing all heat to promote the desired extents of reaction in each reaction zone solely from the exothermicity of chemical reactions in the process;
recirculating the majority of gas from the second reaction zone to provide the hydrogen-rich gas stream to the first reaction zone; and
recovering hydrogen gas to produce electrical energy such that carbon dioxide produced as emissions from the process electrical energy production is less than carbon dioxide emissions from combusting the same feedstock with oxygen.

2. A process for the conversion of a hydrocarbon feedstock as recited in claim 1, wherein finely divided solid fuel is injected into the first reaction zone and both reactions occur in entrained flow or fluidized bed reaction zones with fine solid particles being carried or suspended by the gas stream moving through the reaction zones, but wherein solid particles in the second reaction zone may have sufficient density to settle out countercurrent to the gaseous flow.

3. A process for the conversion of a hydrocarbon feedstock as recited in claim 1, wherein the two reaction zones are partially overlapping and heat is transferred from the first reaction zone to the second by nesting one reaction zone within the other, with separation by a heat conducting and radiating wall.

4. A process for the conversion of a hydrocarbon feedstock as recited in claim 1, wherein the first and second reaction zones are represented by temperatures between 500 and 1200° C. and pressures between 2 and 80 atmospheres.

5. A process for the conversion of a hydrocarbon feedstock as recited in claim 1, wherein the extent of carbon conversion of the solid fuel and dissociation of the methane to carbon and hydrogen may be controlled across a range of up to about 99% conversion by varying the volume of hydrogen-rich gas recycle and conditions of pressure, temperature, reactants residence time, and sometimes catalysis in both reaction zones.

6. A process for the conversion of a hydrocarbon feedstock as recited in claim 1, wherein the continuously removed carbon product is recovered as a clean fuel product with at least 80% of feedstock sulfur, nitrogen and ash removed and/or recovered for use as a solid non-fuel product.

7. A process for the conversion of a hydrocarbon feedstock as recited in claim 1, wherein methane and carbon monoxide may be recovered in lower volumes than hydrogen for conversion to heat and/or electrical energy.

8. A process for the conversion of a hydrocarbon feedstock as recited in claim 1, wherein such carbon monoxide as may be produced from the first reaction zone is partially reacted with gaseous water to produce carbon dioxide and hydrogen.

9. A process for the conversion of a hydrocarbon feedstock as recited in claim 1, wherein gas species containing nitrogen, oxygen, sulfur, or metals are partially removed from a hydrogen-rich gas stream recycled from the second reaction zone to the first reaction zone to the extent that such gas species are not accumulated in the process.

10. A process for the conversion of a hydrocarbon feedstock as recited in claim 1, wherein gas species containing nitrogen, oxygen, sulfur, or metals are partially removed from the product gas steam which exits the process as an energy product, such that the gas species are reduced to concentrations which will not be deleterious to energy conversion devices converting the product gas stream or will not produce emissions to the environment exceeding regulations applying to operation of the process.

11. A process for the conversion of a hydrocarbon feedstock as recited in claim 1, wherein product gases recovered from the process are converted to electrical energy by such devices as high-efficiency fuel cells or gas turbine/electrical generator combinations, which are compatible with operation using high concentrations of hydrogen.

12. The process of claim 1, wherein unconverted carbon char is recovered from the first reaction zone such that this carbon may be applied as a combustion fuel or for such applications gas or liquid filtration.

13. A process for the conversion of a hydrocarbon feedstock as recited in claim 1, wherein solid carbon produced from methane dissociation and recovered from the second reaction zone is in a macro scale form applicable to use as an additive to such structural materials as rubber, plastics, metals, asphalt, concrete, electrodes or other similar materials to improve the desired physical or chemical properties of such other materials.

14. A process for the conversion of a hydrocarbon feedstock as recited in claim 1, wherein solid carbon is produced from methane dissociation in a nano-scale form, such as nanofibers, nanotubes or nano-coke, and wherein the reaction for methane dissociation and carbon nanoforms may be catalyzed.

15. A process for the conversion of a hydrocarbon feedstock as recited in claim 1, wherein solid carbon molecular shapes, particles or fibers are produced from methane dissociation as the primary substance to form such materials as electrodes or other structural 1 forms wherein such techniques as compaction, extrusion, pultrusion, injection molding, and machining may be applied and wherein binder material may used to stabilize such forms or structures.

16. The binder material of claim 15, produced by mild pyrolysis of a portion of the hydrocarbon feedstock used in the process of claim 1.

17. A process for the conversion of a hydrocarbon feedstock as recited in claim 1, wherein solid carbon produced from methane dissociation is utilized as a synthetic combustion fuel with ash, sulfur, nitrogen, oxygen, and trace metals in concentrations at least 80% below that of the feedstock, and wherein such carbon fuel may be sequestered in bulk.

18. A process for the conversion of a hydrocarbon feedstock as recited in claim 1, wherein solid carbon produced from methane dissociation is utilized as a fuel in direct-carbon fuel cells.

19. A process for the conversion of a hydrocarbon feedstock as recited in claim 1, wherein the carbon dioxide produced as emissions from the process electrical energy production is about 50 to about 99% less than carbon dioxide emissions from combusting the same feedstock with oxygen.
